(19) United States
(12) Patent Application Publication
(10) Pub. No.: US 2026/0320218 A1
(43) Pub. Date: Oct. 15, 2026

(54) QUERYING PRIVACY ATTESTED ARTIFICIAL INTELLIGENCE (AI) IN A SECURE ENCLAVE CLOUD ENVIRONMENT

(71) Applicant: Proofpoint Inc., Sunnyvale, CA (US)

(72) Inventors: David Stewart Woodruff, Mapleton, UT (US); Daniel Wallace Rapp, Highland, UT (US); Michael P. Jones, Alpine, UT (US); Steven Val Lyde, Cedar Hills, UT (US); Andre Turgeon, South Jordan, UT (US)

(21) Appl. No.: 19/322,381

(22) Filed: Sep. 8, 2025

Related U.S. Application Data
(60) Provisional application No. 63/789,250, filed on Apr. 15, 2025.

(51) Int. Cl. G06F 21/62

(52) U.S. Cl. CPC G06F 21/6227

(57) ABSTRACT

A method for querying a model utilizing privacy attested AI is described. A query module operating within a secure enclave cloud environment receives a query from a message processing computing platform external to the secure enclave cloud environment. The query module determines that the query has a valid query signature. The query module also determines that the query matches a list of allowed queries maintained by the query module. The query is provided to a privacy attested AI module within the secure enclave cloud environment. A query result for the query is generated using a trained model on the privacy attested AI module. The privacy attested AI module provides the query result to the query module. The query module sends the query result to the message processing computing platform.

### RELATED APPLICATION

The present application is based on and claims the benefit of U.S. provisional patent application Serial No. 63/789,250, titled “Privacy Attested Artificial Intelligence (AI),” filed Apr. 15, 2025; the contents of that application is hereby incorporated by reference in its entirety.

### FIELD

This disclosure relates generally to training models for classification and, more specifically, to utilizing a secure enclave cloud environment to collect private training data for privacy attested artificial intelligence (AI) usage and cryptographically ensure that the private training data and the model trained on the private training data remain secure.

### BACKGROUND

Use of artificial intelligence (AI) has continued to grow, especially with the advent of large language models (LLMs). As the number of applications for AI grows, so does the need for high quality training data for the models utilized for the AI. In addition, people and companies have become more concerned about protecting their private data, seeking assurances that their private information will never be exposed to bad actors and/or to the employees of companies that utilize their private data. Nevertheless, private data remains one of the best sources of training data for AI models since it aligns with the expected data that the AI models will be analyzing. There continues to be a need to protect private information while ensuring that models can accurately represent real-world scenarios.

### SUMMARY

A method for querying a model utilizing privacy attested AI is described. A query module operating within a secure enclave cloud environment receives a query from a message processing computing platform external to the secure enclave cloud environment. The query module determines that the query has a valid query signature. The query module also determines that the query matches a list of allowed queries maintained by the query module. The query is provided to a privacy attested AI module within the secure enclave cloud environment. A query result for the query is generated using a trained model on the privacy attested AI module. The privacy attested AI module provides the query result to the query module. The query module sends the query result to the message processing computing platform.

The query module may be configured such that the list of allowed queries can only be updated by a code management module within the secure enclave cloud environment using code that includes proper attestation from an auditor. The code management module may notify all stakeholders when a request to update the list of allowed queries is received. The request to update the list of allowed queries may be received by the code management module from an auditor via a software installation pipeline. The request may include a signed attestation by the auditor. Received queries that do not match the list of allowed queries may be rejected by the query module and stored in a list of rejected queries. Executed queries may be stored by the query module in a list of executed queries. Each query may include a message. The query response may indicate a classification of the message.

A data ingestion module operating within the secure enclave cloud environment may receive data from a data owner. The data ingestion module may verify that the data has been properly signed. The data ingestion module may provide the data to the privacy attested AI module. The trained model may be trained using the data. The secure enclave cloud environment may be configured such that the privacy attested AI module does communicate directly with anything outside of the secure enclave cloud environment.

The secure enclave cloud environment may be configured such that training data can only be received from outside the secure enclave cloud environment via the data ingestion module. The data may include owner data indicating that the data owner is authorized to provide training data for the privacy attested AI module. The secure enclave cloud environment may be configured such that the data used for training and the trained model cannot be transferred to any entity outside of the secure enclave cloud environment. The secure enclave cloud environment may be configured such that the data is only stored temporarily in the privacy attested AI module for an agreed upon amount of time. Any data received by the data ingestion module that has not been properly signed may be rejected by the data ingestion module. The trained model may include encrypted model weights that are utilized to respond to the query.

A cloud environment is disclosed. The cloud environment includes a memory and a processor. The processor is configured to execute instructions stored in the memory to receive, by a query module operating within a secure enclave cloud environment of the cloud environment, a query from a message processing computing platform external to the secure enclave cloud environment. The processor is also configured to execute instructions stored in the memory to determine, by the query module, that the query has a valid query signature. The processor is further configured to determine, by the query module, that the query matches a list of allowed queries maintained by the query module. The processor is also configured to execute instructions stored in the memory to provide, by the query module, the query to a privacy attested AI module within the secure enclave cloud environment. The processor is further configured to execute instructions stored in the memory to generate a query result for the query using a trained model on the privacy attested AI module. The processor is also configured to execute instructions stored in the memory to provide, by the privacy attested AI module, the query result to the query module. The processor is further configured to execute instructions stored in the memory to send, by the query module, the query result to the message processing computing platform.

A non-transitory computer readable medium is described. The non-transitory computer readable medium stores instructions operable to cause one or more processors to perform operations to receive, by a query module operating within a secure enclave cloud environment, a query from a message processing computing platform external to the secure enclave cloud environment. The non-transitory computer readable medium also stores instructions operable to determine, by the query module, that the query has a valid query signature. The non-transitory computer readable medium further stores instructions operable to determine, by the query module, that the query matches a list of allowed queries maintained by the query module. The non-transitory computer readable medium also stores instructions operable to provide, by the query module, the query to a privacy attested AI module within the secure enclave cloud environment. The non-transitory computer readable medium further stores instructions operable to generate a query result for the query using a trained model on the privacy attested AI module. The non-transitory computer readable medium also stores instructions operable to provide, by the privacy attested AI module, the query result to the query module. The non-transitory computer readable medium further stores instructions operable to send, by the query module, the query result to the message processing computing platform.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 depicts an illustrative operating environment for performing privacy attested AI on a secure enclave cloud environment in accordance with one or more example embodiments.

FIG. 2 is a block diagram of an example of a system for utilizing privacy attested AI.

FIG. 3 is an illustrative event sequence for seeding a secure enclave cloud environment by administrators.

FIG. 4 is an illustrative event sequence for installing privacy attested AI software in the secure enclave cloud environment.

FIG. 5 is an illustrative event sequence for training a model in a secure enclave cloud environment.

FIG. 6 is an illustrative event sequence for querying a trained model in a secure enclave cloud environment by a message processing computing platform.

FIG. 7 is an illustrative event sequence for updating the list of allowed queries utilized by a query module as part of a secure enclave cloud environment.

FIG. 8 is an illustrative event sequence for auditing a trained model that has been trained on private data as part of a secure enclave cloud environment.

### DETAILED DESCRIPTION

Artificial intelligence (AI) tools use trained models to perform required tasks. For example, an AI tool may use a model trained on many different received emails (both malicious and benign) to detect which emails are malicious. Until the models are trained, the AI tools will not be able to complete the requested tasks. Typically, a model used by an AI tool needs to be trained with an adequate amount of training data to function properly. Oftentimes, the more training data used to train a model will result in a better functioning model.

As the amount of digital data being created and shared continues to increase, the concerns about the privacy of that data become greater. People are hesitant to allow their private data to be used to train models, even when they have high amounts of trust for the companies that are conducting the training. These people worry that their private data may be exposed to malicious actors and used for nefarious purposes. They also worry that any models trained on their private data could be manipulated to expose the private data.

Companies also worry about their private data being exposed. For example, a company may be concerned that a model trained using their private data could be manipulated to determine what direction the company is heading (such as a possible acquisition) or internal problems that the company is facing (such as turnover of a high-level executive). This is because one common private data set used to train models is company messaging (including emails, texts, and chats). If even one employee writes about something in an email that is used as training data, there is a concern that a malicious actor could expose this information by strategically querying the AI tool. For example, if a model is trained using email data and there are emails that discuss a potential acquisition in that email data, a bad actor could generate many different queries for the model asking who the company is going to acquire next (with slight changes in the wording of the query) and the model may deliver this data to the bad actor (especially if the bad actor is given enough chances to try many different queries). Such prompt engineering may expose the private data with disastrous results.

Updates in secure compute environments by cloud providers have made it possible to train and utilize models in the cloud that offer cryptographic attestation. These secure compute environments (also referred to as a secure enclave cloud environment) can provide guarantees such as no secure shell protocol (ssh protocol) access or other external access by data scientists, operators, or administrators, signed documents for verifying the secure compute environment’s identity and integrity, assurances that only authorized code is executed within the secure compute environment, and integration with a key management system to enable data decryption only within the secure compute environment. Training an AI model in such a secure compute environment can ensure that the training data is secure.

Furthermore, tools within the secure compute environment can prevent unauthorized queries, thereby preventing anyone (whether the administrator of the AI model or a malicious actor) from using prompt engineering to attempt to query the trained model for private information. These tools can also prevent the trained model from being exported outside of the secure compute environment. Also, these tools can prevent the administrator from changing any of the code within the secure compute environment without utilizing the keys of data owners (and thus requiring the prior approval of the data owners).

Each data owner may manage their own encryption keys. A separate key may be created for each data owner. The training data may be stored at rest with the corresponding encryption key and can only be decrypted within the secure compute environment. If the encryption key is deleted by the data owner, neither the data owner nor the administrator will have access to the data owner’s data within the secure compute environment, thus ensuring that the data will no longer be used to develop future models. The administrator will be able to use the training data to generate the trained model without ever being able to see the training data.

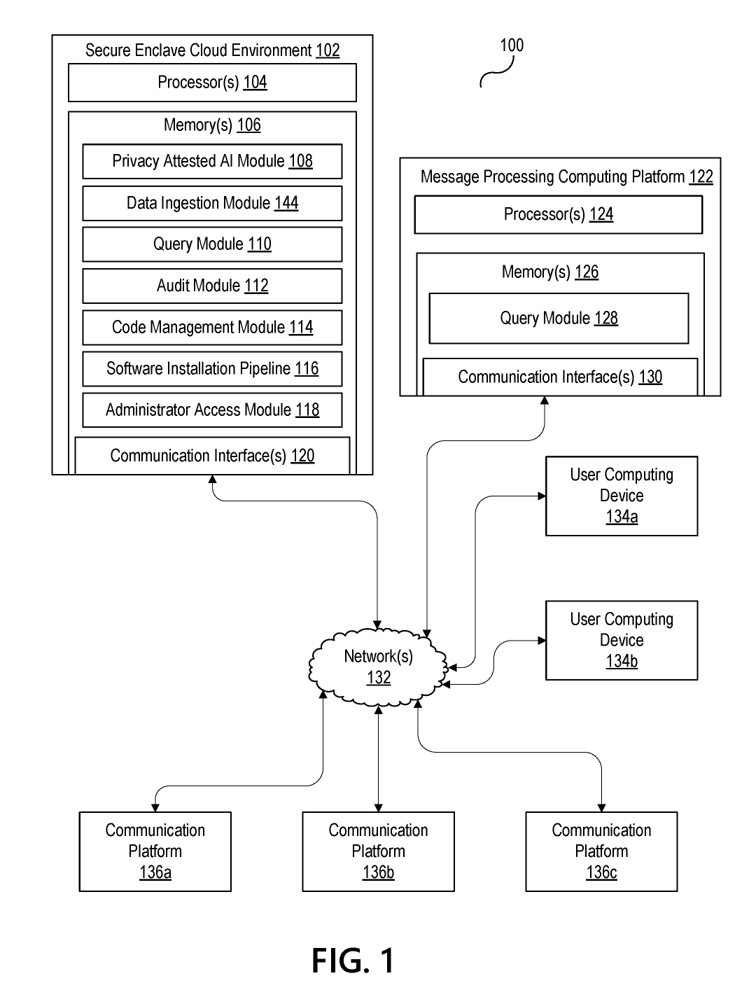

FIG. 1 depicts an illustrative operating environment 100 for performing privacy attested AI in a secure enclave cloud environment 102 in accordance with one or more example embodiments. The secure enclave cloud environment 102 may utilize one or multiple cloud servers to provide the infrastructure needed for the privacy attested AI. Referring to FIG. 1, a computing environment 100 may include various computer systems, computing devices, networks, and/or other operating infrastructure. For example, the computing environment 100 may include a secure enclave cloud environment 102, a message processing computing platform 122, communication platforms 136a-c, user computing devices 134a-b, and one or more network(s) 132.

Network(s) 132 may include one or more wired networks and/or one or more wireless networks that interconnect the secure enclave cloud environment 102, message processing computing platform 122, communication platforms 136, user computing devices 134, and/or other computer systems and/or devices. In addition, each of the secure enclave cloud environment 102, message processing computing platform 122, communication platforms 136, and user computing devices 134 may be special purpose computing devices configured to perform specific functions, as illustrated in greater detail below, and may include specific computing components such as processors, memories, communication interfaces, and/or the like.

The secure enclave cloud environment 102 may include one or more processor(s) 104, one or more memory(s) 106, and one or more communication interface(s) 120. In some instances, the secure enclave cloud environment 102 may be made up of a plurality of different computing devices (e.g., arranged as a computing platform), which may be distributed within a single data center or a plurality of different data centers. In these instances, the one or more processor(s) 104, one or more memory(s) 106, and one or more communication interface(s) 120 included in the secure enclave cloud environment 102 may be part of and/or otherwise associated with the different computing devices that form the secure enclave cloud environment 102.

In one or more arrangements, processor(s) 104 may control operations of the secure enclave cloud environment 102. Memory(s) 106 may store instructions that, when executed by the processor(s) 104, cause the secure enclave cloud environment 102 to perform one or more functions, as discussed below. The communication interface(s) 120 may include one or more wired and/or wireless network interfaces, and the communication interface(s) 120 may connect the secure enclave cloud environment 102 to one or more networks 132 and/or enable the secure enclave cloud environment 102 to exchange information and/or otherwise communicate with the message processing computing platform 122 connected to the network 132.

In one or more arrangements, memory(s) 106 may store and/or otherwise provide a plurality of modules (which may include instructions that may be executed by processor(s) 104 to cause the secure enclave cloud environment 102 to perform various functions) and/or databases (which may store data used by the secure enclave cloud environment 102 in performing various functions). Each module may be a code and infrastructure pair. The memory(s) 106 may store and/or otherwise provide a privacy attested AI module 108, a data ingestion module 144, a query module 110, an audit module 112, a code management module 114, a software installation pipeline 116, and an administrator access module 118. The secure enclave cloud environment 102 may be configured during seeding such that the communication interfaces 120 do not allow direct communication between the message processing computing platform 122 and the privacy attested AI module 108. Instead, the message processing computing platform 122 (and any other computing devices outside the secure enclave cloud environment 102) must communicate with the data ingestion module 144, the query module 110, the audit module 112, the code management module 114, the software installation pipeline 116, or the administrator access module 118, and each of the data ingestion module 144, the query module 110, the audit module 112, the code management module 114, the software installation module 116, and the administrator access module 118 will act as intermediaries to facilitate communications with the privacy attested AI module 108. In this way, the secure enclave cloud environment 102 may provide cryptographic attestation (as verified by an auditor with the proper attestation key) that the training data and the trained model in the privacy attested AI module 108 are not accessible to any users, including the data owners, one or more auditors, multiple administrators, or developers.

The privacy attested AI module 108 may store instructions that cause the secure enclave cloud environment 102 to decrypt received encrypted data from data owners and utilize the decrypted data as training data for one or more trained models. The trained models may be trained on training data from multiple data owners, where the training data includes personal and private information of the data owners. Thus, the trained model is trained on training data that is not typically used for training trained models due to the risk of exposure of either the training data directly or indirectly by querying the trained model. Because the trained model exists within the privacy attested AI module 108 within the secure enclave cloud environment 102, where the secure enclave cloud environment 102 includes provisions that prevent any outsider from directly querying the trained model or accessing the model weights or training data, data owners can safely provide their full data sets (such as all incoming and outgoing company emails) without risk that a bad actor could utilize creative querying to access the training data via the trained model.

In some instances, the data ingestion module 144 may store instructions that cause the secure enclave cloud environment 102 to receive encrypted data and then provide the encrypted data to the privacy attested AI module 108 for use as training data for a trained model. The encrypted data may be received from data owners that have an encryption key associated with the privacy attested AI module 108 (where the privacy attested AI module 108 has a corresponding decryption key). Thus, the encrypted data provided to the secure enclave cloud environment 102 via the data ingestion module 144 may only be decrypted by the privacy attested AI module 108 within the secure enclave cloud environment 102 (and the privacy attested AI module 108 may include instructions that prevent the decryption key from being transferred out of the privacy attested AI module 108).

The query module 110 may store instructions that cause the secure enclave cloud environment 102 to implement bulk mail detection, classification, and enforcement. The query module 110 may receive queries for the trained model generated by a query module 128 in the memory 126 of the message processing computing platform 122. These queries may include requests to classify a message (such as an email or text message) or requests to identify whether a message is malicious. The query module 110 may be implemented such that only queries that match a narrowly tailored list of allowed queries will be provided to the privacy attested AI module 108 to prevent the exposure of the training data used to train the trained model. For example, queries that attempt to extract private information from the trained model (concerning the training data provided by the data owner) will be rejected by the query module 110 and will not be provided to the privacy attested AI module 108. Furthermore, queries that are rejected by the query module 110 may be stored in the secure enclave cloud environment 102 and later accessed by an auditor (along with information about who requested the rejected query).

The audit module 112 may store instructions that cause the secure enclave cloud environment 102 to cooperate with properly requested audits. The audit module 112 may receive a request for an audit from an auditor. In some configurations, the request for an audit may include an attestation key that has been distributed to an auditor to verify that the auditor has the appropriate attestation key. In one configuration with multiple auditors, an audit request may only be approved if the audit request has the appropriate number of attestation keys. For example, an auditor may only be able to successfully request an audit if at least two of the auditors have provided their attestation keys. The audit module 112 may verify that an audit has been properly requested, and if it has, the audit module 112 may collect the appropriate information for the audit (such as the training metrics, the rejected queries, the current list of allowed queries, the list of executed queries, the current list of rules required in a code check, and the privacy attested AI module code stored in the code management module 114) and provide this information in an audit response to the requesting auditor.

The code management module 114 may store instructions that ensure the proper functionality of all software installed in the secure enclave cloud environment 102. After the initial seeding of the secure enclave cloud environment 102, the code management module 114 may be the only interface to receive and update the software utilized in the secure enclave cloud environment 102. The code management module 114 may receive software (such as code for the privacy attested AI module 108) via a software installation pipeline 116 that is controlled from within the secure enclave cloud environment 102. When a developer submits software to the software installation pipeline 116 for installation in the secure enclave cloud environment 102, the software installation pipeline 116 provides that submitted code (such as the privacy attested AI software) to the auditor(s) for review and attestation. The auditor(s) may review the received code and provide an attestation (using an attestation key) that the code follows an agreed upon set of rules for all software to operate in the secure enclave cloud environment 102. Any code that does not include the proper attestation from the auditor(s) will not be installed by the code management module 114 for use in the secure enclave cloud environment 102.

The administrator access module 118 may be utilized by multiple administrators to access the secure enclave cloud environment 102 after setup for emergency purposes. During setup, the administrators may install privacy attested AI seed code to the secure enclave cloud environment 102 to enforce the initial rules of the secure enclave cloud environment 102. Each administrator may have an administrator distributed key, where all (or a large percentage of the total number) need to be combined together to access/change the secure enclave cloud environment 102. Once the administrators have completed the seeding of the secure enclave cloud environment 102, they may exit the secure enclave cloud environment 102 so that one or more developers can begin installing software (such as privacy attested AI software) in the secure enclave cloud environment 102.

The communication platforms 136 may be configured to send messages using a communications service. The communication platforms 136 may include a server device used to send bulk or spam messages to users. The communication platforms 136 may also include a communications platform as a service (CPaaS) that provides bulk messaging sending capabilities. Alternatively, the communication platforms 136 may include a consumer device or any other device that may be used to send messages to users.

The user computing devices 134 may be configured to be used by respective users to receive messages from the communication platforms 136, and may also be able to send messages. The user computing devices 134 could be user-owned devices, employer-provided devices, or other types of devices used by respective users. The user computing devices 134 may be configured to present one or more user interfaces associated with messaging functions as described below.

In one or more arrangements, a communication service involves many different devices, and any given device may be able to receive and send various types of messages, including text messages, emails, and chats, from and to any number of other devices. As used herein, the communication platforms 136 and the user computing devices 134 may represent respective senders and recipients of bulk or spam messages in order to illustrate one or more aspects of the disclosure. Thus, although the examples below describe the communication platforms 136 sending exemplary messages to the user computing devices 134, which may be flagged as malicious messages, some implementations of the disclosure may include many senders and receivers of messages, which may be capable of sending various messages to each other.

The message processing computing platform 122 may utilize the secure enclave cloud environment 102 for queries about incoming messages. The message processing computing platform 122 may include one or more processors 124 and one or more memories 126. The memories 126 may include code that can be executed by the processors 124. For example, the message processing computing platform 122 may have code for a query module 128 that can generate an appropriate query for a trained model within the secure enclave cloud environment 102. The query may be provided to the secure enclave cloud environment 102 via a communication interface 130 as part of the message processing computing platform 122.

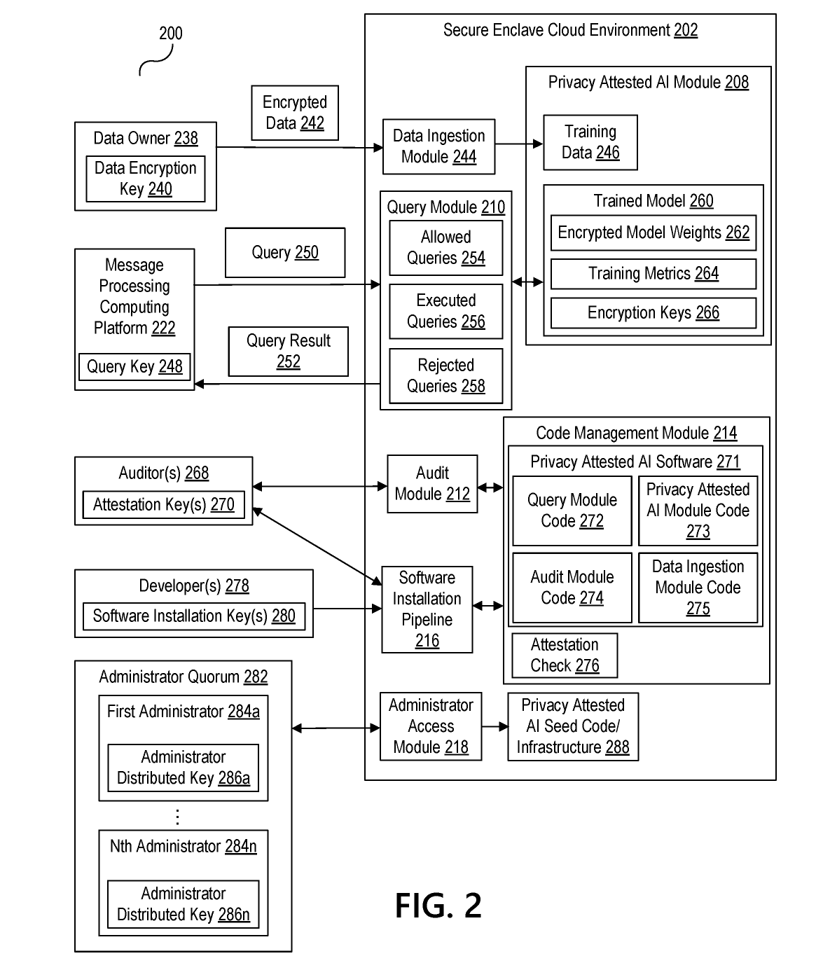

FIG. 2 is a block diagram of an example of a system 200 for utilizing privacy attested AI in a secure enclave cloud environment 202. The system 200 may include a secure enclave cloud environment 202, one or more data owners 238, a message processing computing platform 222, one or more auditors 268, one or more developers 278, and an administrator quorum 282 that includes a first administrator 284a through an nth administrator 284n.

The secure enclave cloud environment 202 may be managed by a cloud computing platform. Specifically, the secure enclave cloud environment 202 may operate on one or more cloud-based servers that include software and hardware built to allow for cryptographic attestation of the security of data and trained models that are stored and utilized within the secure enclave cloud environment 202.

The initialization/seeding of the secure enclave cloud environment 202 may be performed by multiple administrators 284a-n as part of an administrator quorum 282. Each administrator 284 may be assigned an administrator distributed key 286a-n. After seeding, write access from outside the secure enclave cloud environment 202 is only possible if all (or most) of the administrator distributed keys 286 are utilized together. This is due to the privacy attested AI seed code/infrastructure 288 of the secure enclave cloud environment 202 as initially seeded by the administrators 284 (as part of the administrator quorum 282). When the secure enclave cloud environment 202 is initially setup, the secure enclave cloud environment 202 does not have any access restrictions. The administrators 284 may access the secure enclave cloud environment 202 via an administrator access module 218 and install the privacy attested AI seed code/infrastructure 288, which defines the access restrictions and operating rules of the secure enclave cloud environment 202 for privacy attested AI operation. Once the administrators 284 have finished seeding the secure enclave cloud environment 202, all of the administrators 284 may leave the secure enclave cloud environment 202 (discontinue their current access). Once all the administrators 284 have left the secure enclave cloud environment 202 after the initial seeding, the administrators 284 can only regain access to the secure enclave cloud environment 202 by forming an administrator quorum 282 (with the requisite number of administrator distributed keys 286) and utilizing the administrator distributed keys 286 to gain access using the administrator access module 218.

The privacy attested AI seed code/infrastructure 288 may define future access to the secure enclave cloud environment 202 by the administrators 284 using an administrator access module 218. The administrator access module 218 may prevent administrator access to the secure enclave cloud environment 202 (such as to make changes to the privacy attested AI software 271 or to access the training data 246 or trained model 260) unless an administrator quorum 282 has provided the requisite number of administrator distributed keys 286. For example, if there are 10 administrators 284, the administrator access module 218 may require that at least 8 administrator distributed keys 286 are provided for administrators 284 to access the secure enclave cloud environment 202. Thus, after seeding the secure enclave cloud environment 202, the administrators 284 may only be involved with the functioning of the secure enclave cloud environment 202 when a disastrous break has occurred (something that cannot be fixed by simply updating the privacy attested AI software 271).

Each administrator 284 may be from a different company (including at least one for the managing company that includes the developers 278). In one configuration, some of the administrators 284 may exist in different countries or regions of the world. The administrators 284 (as an administrator quorum 282) will agree to the rules needed for the proper operation of privacy attested AI within the secure enclave cloud environment 202. Once these rules have been agreed upon and the privacy attested AI seed code/infrastructure 288 has been implemented in the secure enclave cloud environment 202, the administrators 284 may leave the secure enclave cloud environment 202 and turn it over to the developers 278. The privacy attested AI seed code/infrastructure 288 may establish the administrator access module 218, the software installation pipeline 216, and the code management module 214. The other modules within the secure enclave cloud environment 202 may be installed/updated by developers 278 via the software installation pipeline 216 and the code management module 214.

The developers 278 may have one or more software installation keys 280. Only software that has been authenticated with a software installation key 280 may be passed to the software installation pipeline 216 (in other words, the software installation pipeline 216 will reject software and code that has not been properly authenticated with a software installation key 280). The software installation pipeline 216 may then provide any received software (that has been properly authenticated) to an auditor 268 for attestation. The auditor 268 may review the software and either provide attestation that the software meets the agreed upon privacy attested AI software requirements (by adding an attestation signature to the software using the attestation key 270 assigned to the auditor 268) or reject the software. If the auditor 268 approves the software (i.e., attests that the software meets the agreed upon privacy attested AI software rules), the auditor 268 will provide the software with the attestation signature to the code management module 214 via the software installation pipeline 216. The code management module 214 can then verify that the software has the appropriate attestation signature and begin installation of the software within the secure enclave cloud environment 202.

The secure enclave cloud environment 202 may include a privacy attested AI module 208. The privacy attested AI module 208 may utilize received training data 246 to train and maintain a trained model 260. The trained model 260 may be trained to provide classification of emails and other messages. For example, the trained model 260 may receive a query 250 concerning whether a particular email is a phishing email. Utilizing encrypted model weights 262 and training metrics 264 within the trained model 260, the trained model 260 may process the query 250 (which may include the message or metadata corresponding to the message) and provide a query result 252 that responds to the query 250 (for example, an indication that the particular email is a phishing email).

The privacy attested AI module 208 may be configured such that no devices outside the secure enclave cloud environment 202 can communicate directly with the privacy attested AI module 208. Instead, the privacy attested AI module 208 can only be accessed indirectly via other modules within the secure enclave cloud environment 202. For example, only a data ingestion module 244, a query module 210, an audit module 212, and a code management module 214 within the secure enclave cloud environment 202 can communicate directly with the privacy attested AI module 208. All modules and devices external to the secure enclave cloud environment 202 can only communicate with one of the data ingestion module 244, the query module 210, the audit module 212, and/or the code management module 214 in order to access the services provided by the privacy attested AI module 208. This ensures that only certain interactions with the privacy attested AI module 208 are permitted (and that the privacy attested AI module code 273 cannot be changed by a developer 278 unless the code has been reviewed and signed with an attestation signature by an auditor 268). Any changes to the privacy attested AI software 271 (including the query module code 272, the privacy attested AI module code 273, the audit module code 274, and the data ingestion module code 275) may automatically trigger a notification to all the stakeholders (e.g., all data owners 238 that have contributed training data 246 and all auditors 268) of the change. This includes changes to the privacy attested AI software 271 by developers 278 (via the software installation pipeline 216) or by administrators 284 (via the administrator access module 218).

The privacy attested AI module 208 may only receive training data 246 via the data ingestion module 244. Data owners 238 may provide encrypted data 242 signed by a data encryption key 240 to the data ingestion module 244. The data ingestion module 244 will pass the encrypted data 242 to the privacy attested AI module 208. The privacy attested AI module 208 will then decrypt the encrypted data 242 using a corresponding data encryption key 266 (linked to the data encryption key 240 used by the data owner 238) and utilize the training data 246 for training the trained model 260. The privacy attested AI module 208 may be configured such that the data decryption keys do not leave the secure enclave cloud environment 202 ensuring that the training data 246 can only be decrypted within the secure enclave cloud environment 202. The training data 246 may only be stored temporarily in the secure enclave cloud environment 202 (and thus the privacy attested AI module 208 will not maintain a database of the training data 246 for longer than an agreed upon amount of time negotiated with each data owner 238). Any data (encrypted or unencrypted) received by the data ingestion module 244 that does not include the proper signature may be rejected by the data ingestion module 244 and the data owner 238 may be notified of the rejection. Only data owners 238 that desire to provide their data to be used as training data 246 will attempt to provide encrypted data 242 to the data ingestion module 244. Furthermore, only those data owners 238 that have agreed to the privacy attested AI module 208 constraints will have the proper keys and know the proper communication protocols of both the secure enclave cloud environment 202 and the data ingestion module 244.

The privacy attested AI module 208 may generate/train a trained model 260 using the unencrypted training data 246. The trained model 260 may include encrypted model weights 262 that are utilized by the trained model 260 to respond to queries 250. The privacy attested AI module 208 may be programmed such that the trained model 260 and the encrypted model weights 262 cannot leave the privacy attested AI module 208 or the secure enclave cloud environment 202. For example, the privacy attested AI module code 273 may include specific instructions prohibiting the privacy attested AI module 208 from providing the trained model 260 or the encrypted model weights 262 to any modules within the secure enclave cloud environment 202 or to any devices outside of the secure enclave cloud environment 202. As discussed before, the privacy attested AI module code 273 may also prevent the privacy attested AI module 208 from communicating with anything (transmit or receive) outside of the secure enclave cloud environment 202 and may restrict communications with modules within the secure enclave cloud environment 202.

The query module 210 may receive queries 250 from a message processing computing platform 222 external to the secure enclave cloud environment 202. The message processing computing platform 222 may be utilized to identify potentially malicious messages and generate instream alerts based on real-time message monitoring that includes querying the trained model 260 of the privacy attested AI module 108. However, the message processing computing platform 222 may only communicate indirectly with the privacy attested AI module 208 via the query module 210. The message processing computing platform 222 may send various queries 250 to the query module 210. Each query 250 may be signed with a query key 248 managed by the message processing computing platform 222 to ensure that only properly signed queries 250 are processed by the query module 210. Each query 250 may include the message to be classified (e.g., the message that is being evaluated as a potential phishing message) along with the specific query (i.e., the request of the trained model). The query module 210 may maintain a list of allowed queries 254. The list of allowed queries 254 may be defined by the developer 278 during initial setup (and signed by the auditor 268 with an attestation key 270) and may not be changed/updated by the developer 278 without the proper keys (i.e., without additional review and signature by the auditor 268 with an attestation key 270). Any changes to the list of allowed queries 254 will trigger a notification to all concerned parties (e.g., all data owners 238, the auditors 268, and the developers 278) notifying them of the change and the change requestor. Furthermore, any changes to the list of allowed queries 254 must include the attestation (i.e., be signed using the attestation key 270) by the auditor 268 signifying that the changes to the list of allowed queries 254 meet certain predefined rules for the list of allowed queries 254 (i.e., that the queries are limited in scope and cannot attempt to query the trained model 260 for private information).

If a received query 250 matches the list of allowed queries 254, the query module 210 may pass the received query 250 to the privacy attested AI module 208, which will utilize the trained model 260 to obtain a query result 252. The privacy attested AI module 208 may then pass the query result 252 to the query module 210 and the query module 210 will pass the query result 252 to the message processing computing platform 222. The query module 210 may maintain a list of executed queries 256 that can be accessed only by an audit request from an auditor 268 via the audit module 212 and utilizing the attestation key 270. The query module 210 may also maintain a list of rejected queries 258 (such as queries 250 that did not match the list of allowed queries 254). The list of rejected queries 258 may also only be accessed by an audit request from an auditor 268 with the attestation key 270 via the audit module 212.

The audit module 212 may process audit requests from an auditor 268. An auditor 268 may be a 3^{rd} party (such as a private company that performs audits as a service) that has contracted with the data owners 238 and the managing company of the secure enclave cloud environment 202 (typically the same company that manages the message processing computing platform 222). Multiple auditors 268 may be utilized to maintain higher levels of security. Each auditor 268 may have an attestation key 270 that allows the auditor 268 to provide an attestation signature to software submitted via the software installation pipeline 216 by a developer 278 for installation within the secure enclave cloud environment 202 and to request audits via the audit module 212. An auditor 268 may periodically or sporadically request an audit from the audit module 212 within the secure enclave cloud environment 202. In response to a proper audit request (e.g., an audit request that has been signed by the attestation key 270), the audit module 212 may obtain data from other modules within the secure enclave cloud environment 202. For example, the audit module 212 may obtain the list of allowed queries 254, the list of executed queries 256, and the list of rejected queries 258 from the query module 210. The audit module 212 may also obtain the privacy attested AI software 271 from the code management module 214. The audit module 212 may then provide the obtained information to the auditor 268 as part of an audit report.

Audit reports may only be requested by the auditor 268 and are only provided to the auditor 268 by the audit module 212. However, an audit request may trigger a notification to all stakeholders. The auditor 268 may then distribute the audit report or verify that it meets expectations to the stakeholders. An auditor 268 may also test the secure enclave cloud environment 202 by sending test queries 250 that do not meet the list of allowed queries 254 to see if the query module 210 rejects the test queries 250. The auditor 268 may notify the stakeholders if the query module 210 accepts an improper test query 250.

The code management module 214 may perform an attestation check on the privacy attested AI software 271 received from the software installation pipeline 216 (i.e., confirm that the privacy attested AI software 271 includes an attestation signature by an auditor 268). The code management module 214 may then install the privacy attested AI software 271 (either to instantiate the code or update existing code). The code management module 214 may thus be the only module within the secure enclave cloud environment 202 that can receive code and install that code within the secure enclave cloud environment 202. The code management module 214 may maintain a copy of the privacy attested AI software 271 (such as the privacy attested AI module code 273, the data ingestion module code 275, the query module code 272, and the audit module code 274).

Whenever new code or code changes are provided to the code management module 214 by a developer 278 (via the software installation pipeline 216 and an auditor 268), the code management module 214 may be configured to notify all stakeholders of both the change in code and confirmation that the new code has the proper attestation signature from an auditor 268 (i.e., that the code has passed an attestation check 276). In some configurations, changes to each of the privacy attested AI module code 273, the data ingestion module code 275, the audit module code 274, and/or the query module code 272 may each require different notification rules. For example, changes to the privacy attested AI module code 273 and the query module code 272 may automatically notify all stakeholders when such a change is made or requested, while changes to the data ingestion module code 275 may only require that the auditor(s) 268 and developers 278 be notified of the change.

The privacy attested AI module 208 may utilize the trained model 260 to generate distilled trained models that can utilize the training of the trained model 260 for optimized results. For example, a distilled trained model of the trained model 260 may be generated that includes only some of the encrypted model weights 262 and can thus operate faster than the original trained model 260 for specific purposes. The query module 210 may direct queries 250 to either the original trained model 260 or to a distilled trained model based on the contents of the query 250. In one configuration, a distilled trained model may be a non-chatty model (e.g., a model that is only capable of providing a classifier based on a query 250 and thus cannot respond to queries 250 that attempt to extract private information from the distilled trained model). The non-chatty model may only be capable of responding to a query with a yes/no answer.

The privacy attested AI module 208 may maintain a persisted training data 246 set to train and maintain the trained model 260. Any training data 246 that is stored by the privacy attested AI module 208 may be stored encrypted. The privacy attested AI module 208 may be configured such that it will not transmit any of the training data 246 out of the secure enclave cloud environment 202 (and none of the other modules within the secure enclave cloud environment 202 will be capable of receiving the training data 246 from the privacy attested AI module 208 or transmitting the training data 246 to a device outside of the secure enclave cloud environment 202). Furthermore, the secure enclave cloud environment 202 is setup in such a way that the trained model 260 and the corresponding encrypted model weights 262 will not be transferred out of the secure enclave cloud environment 202.

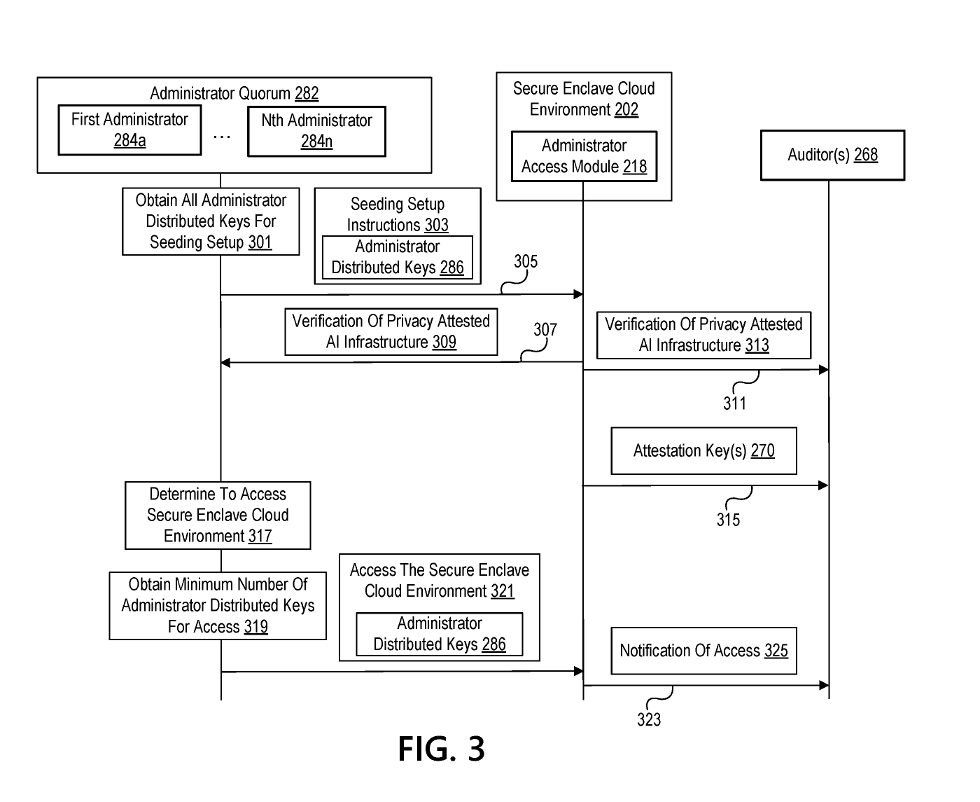

FIG. 3 is an illustrative event sequence for seeding a secure enclave cloud environment 202 by administrators 284. Prior to startup, the secure enclave cloud environment 202 may not have the proper software and infrastructure for providing privacy attested AI functionality. One or more administrators 284a-n (as part of an administrator quorum 282) may access the secure enclave cloud environment 202 and install the necessary software and infrastructure (i.e., the privacy attested AI seed code/infrastructure 288) so the secure enclave cloud environment 202 can provide privacy attested AI functionality. For example, the administrators 284 may install software and infrastructure that facilitates the administrator access module 218 (to prevent future access to the secure enclave cloud environment 202 unless all or most of the administrators 284 (and the corresponding administrator distributed keys 286) are utilized together), the software installation pipeline 216 (to require that all privacy attested AI software 271 be provided to an auditor 268 and be signed using an attestation key 270), and the code management module 214 (to only install software that has the proper attestation signature within the secure enclave cloud environment 202).

The group of administrators 284 (the first administrator 284a through the nth administrator 284n) may get together to form an administrator quorum 282 by obtaining 301 all the administrator distributed keys 286 for seeding setup. The administrator quorum 282 may require all or a significant portion of the total administrators 284 to work together to access/seed the secure enclave cloud environment 202 (i.e., because each of the administrators 284 may be assigned an administrator distributed key 286, where access to the administrator access module 218 on the secure enclave cloud environment 202 requires all or a significant portion of the administrator distributed keys 286). The administrator quorum 282 may agree upon the specific rules for the privacy attested AI seed code/infrastructure 288, and they may each (along with one or more auditors 268) verify at the time of seeding that the privacy attested AI seed code/infrastructure 288 installed within the secure enclave cloud environment 202 meets all of those rules. The administrator quorum 282 may thus send 305 seeding setup instructions 303 to the secure enclave cloud environment 202 to install the administrator access module 218, the software installation pipeline 216, and the code management module 214. Each auditor 268 may then be assigned an attestation key 270 that can be used to provide an attestation signature to software that has been committed to the software installation pipeline 216.

Upon receiving the seeding setup instructions 303, the secure enclave cloud environment 202 may send 307 a verification of privacy attested AI infrastructure 309 to the administrators 284 of the administrator quorum 282. The verification of privacy attested AI infrastructure 309 may confirm that the seeding setup instructions 303 have been followed and the secure enclave cloud environment 202 has been properly seeded. The secure enclave cloud environment 202 may also send 311 a verification of privacy attested AI infrastructure 313 to the auditors 268. As part of the seeding of the secure enclave cloud environment 202, the secure enclave cloud environment may send 315 attestation keys 270 to the auditors 268.

Once the administrator quorum 282 has finished seeding the secure enclave cloud environment 202, all of the administrators 284 may leave the secure enclave cloud environment 202, thereby restricting future access by any of the administrators 284 unless an administrator quorum 282 (having the requisite number of administrator distributed keys 286) collectively determines 317 to access the secure enclave cloud environment 202 via the administrator access module 218. This is accomplished by the administrator quorum 282 obtaining 319 the minimum number of administrator distributed keys 286 required by the administrator access module 218 and then utilizing those administrator distributed keys 286 collectively to access 321 the secure enclave cloud environment 202. When the administrator quorum 282 accesses 321 the secure enclave cloud environment 202, a notification 325 of the access may be provided 323 to the one or more auditors 268. The auditors 268 can then notify the data owners 238 and/or other stakeholders such as the developers 278 that the administrators 284 have accessed the secure enclave cloud environment 202.

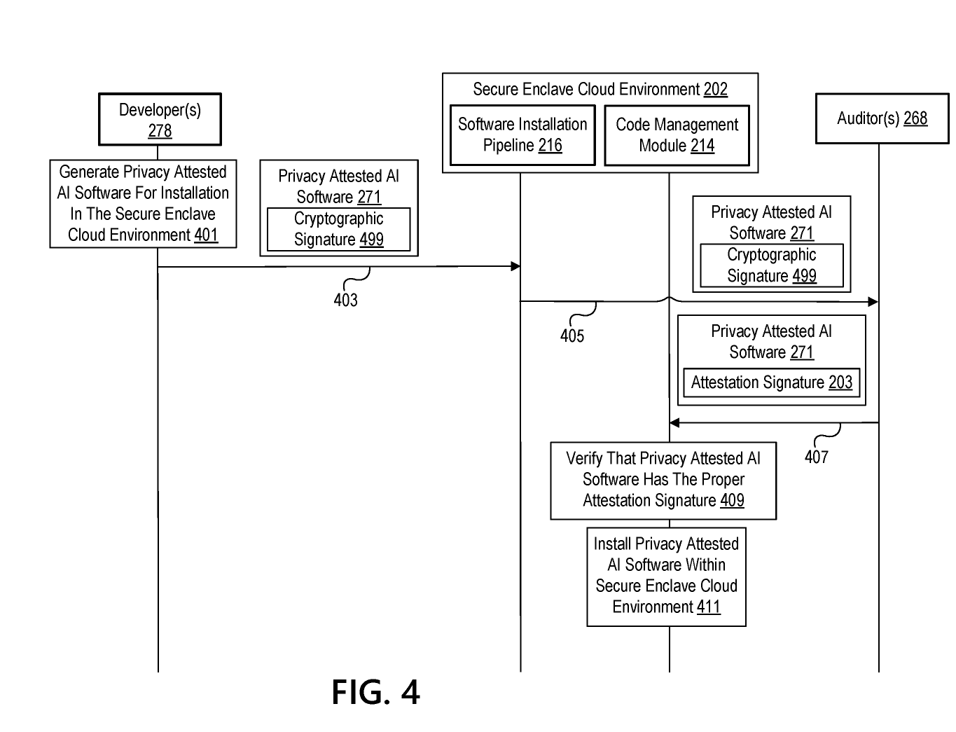

FIG. 4 is an illustrative event sequence for installing privacy attested AI software 271 in the secure enclave cloud environment 202. One or more developers 278 may generate 401 privacy attested AI software 271 for installation in the secure enclave cloud environment 202. The privacy attested AI software 271 may include privacy attested AI module code 273, data ingestion module code 275, query module code 272, and audit module code 274. The privacy attested AI software 271 may be installed right after seeding of the secure enclave cloud environment 202 or may be updated by the developers 278 as necessary to maintain the privacy attested AI operation in the secure enclave cloud environment 202. The privacy attested AI software 271 cannot modify the privacy attested AI seed code/infrastructure 288.

The privacy attested AI module code may be utilized by the developer(s) to train a model within the secure enclave cloud environment using training data received from one or more data owners. Although the developer will not be able to see the training data or the trained model weights, the developer will be able to see training metrics (such as a loss function on training runs) that are initiated by the developer through the software installation pipeline.

The developers 278 may commit 403 the privacy attested AI software 271 (with the proper software installation key 280 assigned to each developer 278) to the software installation pipeline 216 of the secure enclave cloud environment 202. In one configuration, multiple developers 278 must have each properly signed any code changes submitted to the software installation pipeline 216 (including training requests) with the proper software installation keys 280. The software installation pipeline 216 may then send 405 the privacy attested AI software 271 (and the software installation key(s) 280) to one or more auditors 268 for attestation. An auditor 268 may evaluate the privacy attested AI software 271 to ensure it complies with the agreed upon requirements for operation in the secure enclave cloud environment 202 (such as that the privacy attested AI module 208 may only communicate with other modules within the secure enclave cloud environment 202, and that the query module 210 may only forward queries 250 to the trained model 260 that match a list of allowed queries 254). If the privacy attested AI software 271 does not meet those requirements, the privacy attested AI software 271 may be rejected by the auditor 268 (and thus not installed within the secure enclave cloud environment 202). When privacy attested AI software 271 is rejected by the auditor 268, the privacy attested AI software 271 may be returned to the developers 278 and the auditor 268 may notify stakeholders of the rejection. If the privacy attested AI software 271 does meet those requirements, the auditor(s) 268 may add an attestation signature 203, using the attestation key 270 assigned to each auditor 268, to the privacy attested AI software 271 and then provide 407 the privacy attested AI software 271 to the code management module 214 within the secure enclave cloud environment 202.

The code management module 214 may verify 409 that the received privacy attested AI software 271 has the proper attestation signature 203. If the received privacy attested AI software 271 has the proper attestation signature 203, the code management module 214 may install 411 the privacy attested AI software 271 within the secure enclave cloud environment 202. The newly installed privacy attested AI software 271 may then be utilized for privacy attested AI operation in the secure enclave cloud environment 202.

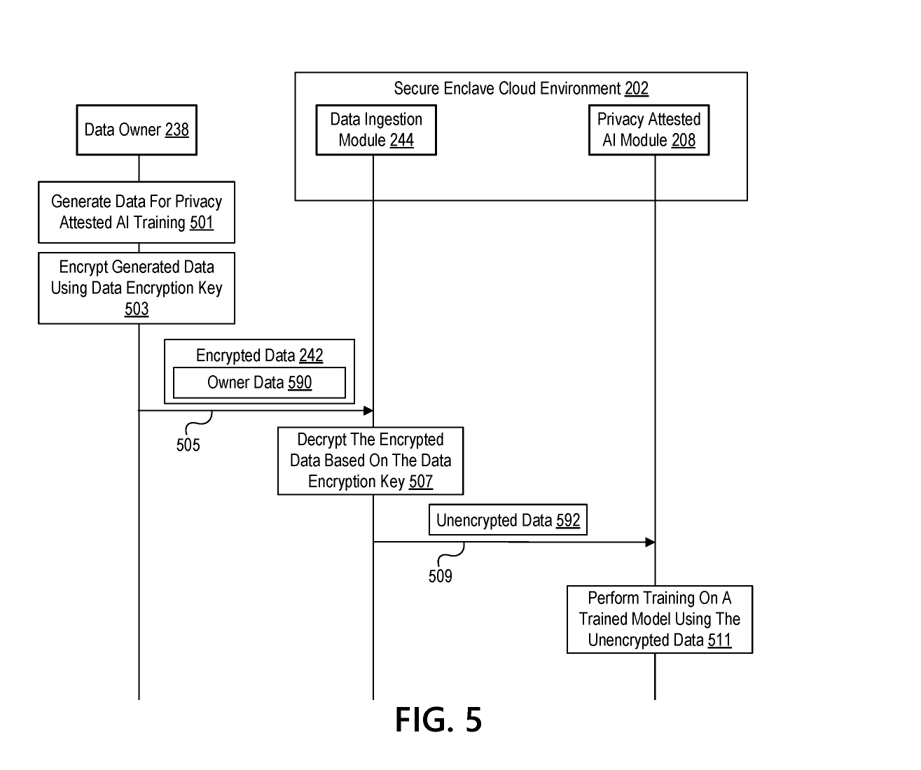

FIG. 5 is an illustrative event sequence for training a model 260 in a secure enclave cloud environment 202. The secure enclave cloud environment 202 may include a data ingestion module 244 and a privacy attested AI module 208. A data owner 238 may generate 501 training data 246. The training data 246 may be emails, text messages, chats, social media posts, documents, and attachments that are generated 501 as part of conducting the data owner’s 238 business. The data owner 238 may curate the training data 246 (i.e., select specific data from an overall data stream generated by users corresponding to the data owner 238) or provide all generated data as training data 246. The data owner 238 may encrypt 503 the training data 246 generated using a data encryption key 240. The data encryption key 240 may be such that only the secure enclave cloud environment 202 has the key for decrypting the data. In other words, the encrypted training data 246 provided by the data owner 238 may only be decrypted within the secure enclave cloud environment 202. The data owner 238 may provide 505 the encrypted data along with owner data 590 (e.g., metadata that identifies the data owner 238 and which keys are for decrypting the encrypted data).

The encrypted data may be received by a data ingestion module 244 within the secure enclave cloud environment 202. The data ingestion module 244 may identify which key is to be used to decrypt the data based on the owner data 590. The data ingestion module 244 may then decrypt 507 the encrypted data and provide 509 the unencrypted data 592 to a privacy attested AI module 208 within the secure enclave cloud environment 202. Alternatively, the data ingestion module 244 may provide the encrypted data 242 to the privacy attested AI module 208, and the privacy attested AI module 208 may decrypt the data using the decryption key. The privacy attested AI module 208 may utilize the unencrypted data as training data 246 to perform training 511 on a trained model 260 of the privacy attested AI module 208.

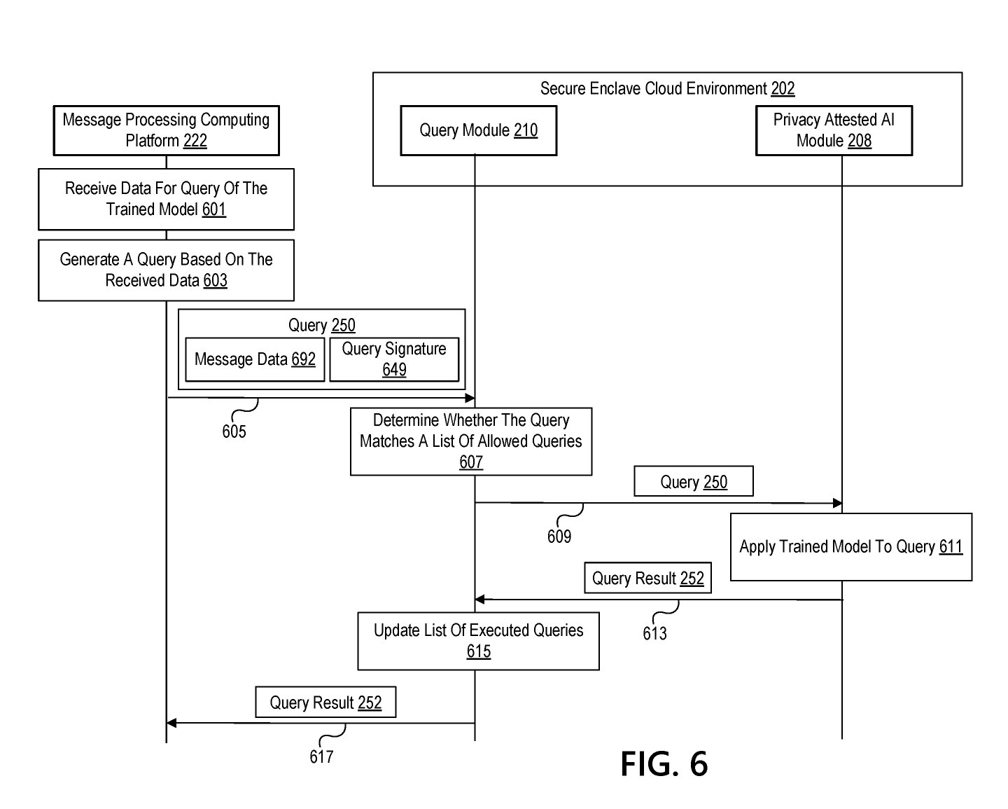

FIG. 6 is an illustrative event sequence for querying a trained model 260 in a secure enclave cloud environment 202 by a message processing computing platform 222. The secure enclave cloud environment 202 may include a query module 210 and a privacy attested AI module 208. The secure enclave cloud environment 202 may be configured such that the privacy attested AI module 208 does not communicate with anything outside of the secure enclave cloud environment 202 and that all queries 250 for the trained model 260 in the privacy attested AI module 208 must be provided to the query module 210.

The message processing computing platform 222 may receive 601 data for a query 250 of the trained model 260 in the privacy attested AI module 208. For example, the message processing computing platform 222 may receive an email that needs to be classified as either phish or not phish. The message processing computing platform 222 may generate 603 a query 250 based on the received data. The query 250 may include message data (such as the message and metadata associated with the message) and a query signature 649 indicating that the query 250 has been signed with the proper query key 248. The query 250 may be sent 605 to the query module 210 by the message processing computing platform 222. In one configuration, the query module 210 may only accept queries 250 that have the proper query signature 649.

The query module 210 may determine 607 whether the query 250 matches a list of allowed queries 254. For example, the query module 210 may determine whether the query 250 is an allowed classification query or whether the query 250 is some other type of query (such as a query 250 that attempts to obtain private information from the trained model 260). If the received query 250 does match the allowed queries 254, the query module 210 may pass 609 the query 250 to the privacy attested AI module 208. If the received query 250 does not match the allowed queries 254, the query module 210 may reject the query 250 and update a list of rejected queries 258 to include the rejected query 250.

For queries 250 that are passed to the privacy attested AI module 208, the privacy attested AI module 208 may apply 611 the trained model 260 to the received query 250 to obtain a query result 252. The query result 252 may indicate a classification of the message that corresponds to the query 250 (e.g., the message is a phishing message or the message is not a phishing message). The privacy attested AI module 208 may pass 613 the query result 252 back to the query module 210. The query module 210 may then update 615 the list of executed queries 256 to include the query 250 and the query result 252 (such as for future audits). The query module 210 may also provide 617 the query result 252 to the message processing computing platform 222. The message processing computing platform 222 may then utilize the query result 252 to allow or reject the message corresponding to the query 250.

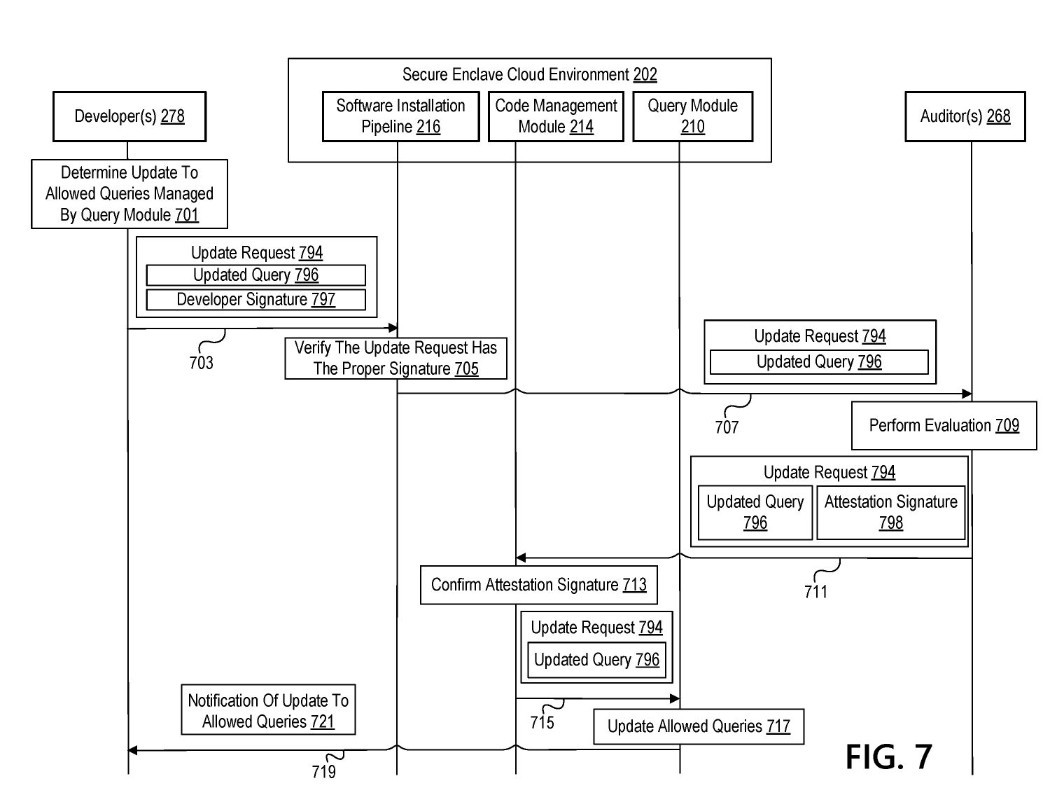

FIG. 7 is an illustrative event sequence for updating the list of allowed queries 254 utilized by a query module 210 as part of a secure enclave cloud environment 202. The secure enclave cloud environment 202 may include a software installation pipeline 216, a code management module 214, and a query module 210. One or more developers 278 (with the proper software installation keys 280) may determine 701 an updated query 796 (or list of queries 796) to be added or removed from the list of allowed queries 254. The developers 278 may send 703 an update request 794 to the software installation pipeline 216 within the secure enclave cloud environment 202. The update request 794 may include the updated query 796 (or queries 796) to be added to or removed from the list of allowed queries 254 maintained by the query module 210 and a developer signature 797 corresponding to the software installation key 280 of the developer 278. The update request 794 to update the list of allowed queries 254 may only be sent 703 to the software installation pipeline 216 (and not to the query module 210, which can only accept queries 250 from the message processing computing platform 222, or to the code management module 214, which can only accept privacy attested AI software 271 that has been properly attested by an auditor 268).

The software installation pipeline 216 may receive the update request 794 and verify 705 the developer signature 797. If the developer signature 797 is missing or is incorrect, the software installation pipeline 216 may reject the update request 794 and notify the auditor 268 of the rejected update request 794. If the software installation pipeline 216 is able to verify the developer signature 797, the software installation pipeline 216 may send 707 the update request 794 along with the updated query 796 to the auditor 268 for attestation. The auditor 268 may receive the update request 794 and perform 709 an evaluation (either automated or manual) that the update request 794 and the corresponding updated query 796 are acceptable. If the auditor 268 (or multiple auditors 268) find that the update request 794 or the updated query 796 are unacceptable (e.g., the updated query 796 does not meet the requirements set by the administrators 284 for operation within the secure enclave cloud environment 202), the auditor 268 may reject the update request 294. If the auditor 268 finds that the update request 294 is acceptable, the auditor 268 may sign the update request 794 with an attestation signature 798 using the attestation key 270. The auditor 268 may then provide 711 the update request 794 and the updated query 796 to the code management module 214. The code management module 214 may confirm 713 that the update request 794 has the proper attestation signature 798 and forward 715 the update request 794 and the updated query 796 to the query module 210.

The query module 210 may receive the update request 794 and may update 717 the list of allowed queries 254 according to the update request 794. The query module 210 may also provide 719 a notification 721 of the update to the list of allowed queries 254 to the developers 278 (to signify that the update request 794 has passed). For example, the query module 210 may generate an email or notification indicating that the list of allowed queries 254 has been updated. In one configuration, the query module 210 may also update a blockchain ledger to indicate to all interested parties that the list of allowed queries 254 has been successfully updated. Any interested parties that wish to obtain more information about the update can request an update from the auditor 268 to verify that the update is acceptable.

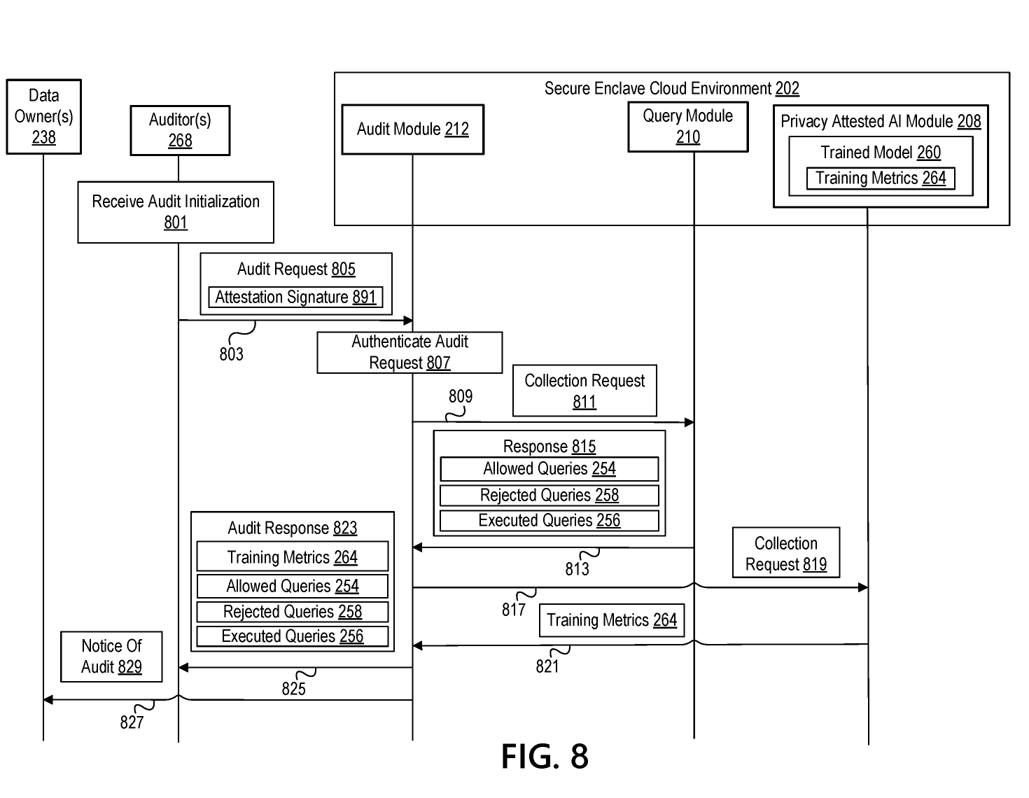

FIG. 8 is an illustrative event sequence for auditing a trained model 260 that has been trained on private training data 246 as part of a secure enclave cloud environment 202. The secure enclave cloud environment 202 may include an audit module 212, a query module 210, and a privacy attested AI module 208. The secure enclave cloud environment 202 may be configured such that the privacy attested AI module 208 can only communicate with other modules operating within the secure enclave cloud environment 202. Thus, no entity outside of the secure enclave cloud environment 202 can communicate directly with the privacy attested AI module 208 (and must instead communicate with the audit module 212 or the query module 210 to indirectly communicate with the privacy attested AI module 208).

An auditor 268 may receive 801 an audit initialization. The audit initialization may be received from one or more data owners 238 or it may be triggered periodically or be triggered based on specific events (such as when a certain number of queries 250 have been processed). The auditor 268 may send 803 an audit request 805 to the audit module 212. The audit request 805 may include a cryptographic attestation signature 891 that verifies that the auditor 268 has the proper attestation key 270. In one configuration, the auditor 268 can send 803 the audit request 805 without notifying the data owners 238 or receiving their consent. In another configuration, at least one data owner 238 must provide a signature using their software installation key 280 to the auditor 268 in order to generate an audit request 805 with the proper cryptographic signature.

The audit request 805 may specify information that is requested (such as training metrics 264, a list of executed queries 256, or a current list of allowed queries 254). The audit request 805 may also request a copy of the privacy attested AI software 271 utilized by the code management module 214 such as the privacy attested AI module code 273, the data ingestion module code 275, the query module code 272, the audit module code 274, or a verification that the current code utilized has passed an attestation check 276. If the audit request 805 includes a request for information that is not authorized (such as for the training data 246 or the encrypted model weights 262), the audit request 805 may be rejected and all interested parties may be notified of the improper audit request 805.

The audit module 212 may verify that the attestation signature 891 is valid/proper. If the attestation signature 891 of the audit request 805 is invalid or improper, the audit module 212 may reject the audit request 805 and notify all of the data owners 238 that an improper audit request 805 has been received. If the attestation signature 891 of the audit request 805 is determined to be valid, the audit module 212 may then collect the requested audit data from the other modules within the secure enclave cloud environment 202. For example, the audit module 212 may send 809 a collection request 811 to the query module 210 requesting to collect the list of allowed queries 254, the list of executed queries 256, and the list of rejected queries 258 from the query module 210. The audit module 212 may also send 817 a collection request 819 to collect the training metrics 264 from the privacy attested AI module 208. The audit module 212 may receive 813 a response 815 from the query module 210 that includes the allowed queries 254, the rejected queries 258, and the executed queries 256. The audit module 212 may also receive 821 the training metrics 264 from the privacy attested AI module 208.

The audit module 212 may then provide 825 an audit response 823 to the auditor 268 that includes the requested information. The audit module 212 may also provide 827 a notice of the audit 829 to all interested parties (such as the data owners 238 and the administrators 284). For example, the audit module 212 may send an email to all interested parties that includes who made the audit request 805, what information was requested, and what information was provided.

For simplicity of explanation, the techniques of FIGS. 3 through 8 are depicted and described herein as respective series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
receiving, by a query module operating within a secure enclave cloud environment, a query from a message processing computing platform external to the secure enclave cloud environment;
determining, by the query module, that the query has a valid query signature;
determining, by the query module, that the query matches a list of allowed queries maintained by the query module;
providing, by the query module, the query to a privacy attested AI module within the secure enclave cloud environment;
generating a query result for the query using a trained model on the privacy attested AI module;
providing, by the privacy attested AI module, the query result to the query module; and
sending, by the query module, the query result to the message processing computing platform.

2. The method of claim 1, wherein the query module is configured such that the list of allowed queries can only be updated by a code management module within the secure enclave cloud environment using code that includes proper attestation from an auditor.

3. The method of claim 2, wherein the code management module notifies all stakeholders when a request to update the list of allowed queries is received.

4. The method of claim 3, wherein the request to update the list of allowed queries is received by the code management module from an auditor via a software installation pipeline, and wherein the request includes a signed attestation by the auditor.

5. The method of claim 1, wherein received queries that do not match the list of allowed queries are rejected by the query module and stored in a list of rejected queries.

6. The method of claim 1, wherein executed queries are stored by the query module in a list of executed queries.

7. The method of claim 1, wherein each query includes a message, and wherein the query response indicates a classification of the message.

8. The method of claim 1, further comprising:
receiving, by a data ingestion module operating within the secure enclave cloud environment, data from a data owner;
verifying, by the data ingestion module, that the data has been properly signed;
providing, by the data ingestion module, the data to the privacy attested AI module; and
training the trained model using the data, wherein the secure enclave cloud environment is configured such that the privacy attested AI module does communicate directly with anything outside of the secure enclave cloud environment.

9. The method of claim 8, wherein the secure enclave cloud environment is configured such that training data can only be received from outside the secure enclave cloud environment via the data ingestion module.

10. The method of claim 8, wherein the data includes owner data indicating that the data owner is authorized to provide training data for the privacy attested AI module.

11. The method of claim 8, wherein the secure enclave cloud environment is configured such that the data used for training and the trained model cannot be transferred to any entity outside of the secure enclave cloud environment.

12. The method of claim 8, wherein the secure enclave cloud environment is configured such that the data is only stored temporarily in the privacy attested AI module for an agreed upon amount of time.

13. The method of claim 8, wherein any data received by the data ingestion module that has not been properly signed is rejected by the data ingestion module.

14. The method of claim 8, wherein the trained model includes encrypted model weights that are utilized to respond to the query.

15. A cloud environment, comprising:
a memory; and
a processor, the processor configured to execute instructions stored in the memory to:
receive, by a query module operating within a secure enclave cloud environment of the cloud environment, a query from a message processing computing platform external to the secure enclave cloud environment;
determine, by the query module, that the query has a valid query signature;
determine, by the query module, that the query matches a list of allowed queries maintained by the query module;
provide, by the query module, the query to a privacy attested AI module within the secure enclave cloud environment;
generate a query result for the query using a trained model on the privacy attested AI module;
provide, by the privacy attested AI module, the query result to the query module; and
send, by the query module, the query result to the message processing computing platform.

16. The cloud environment of claim 15, wherein the query module is configured such that the list of allowed queries can only be updated by a code management module within the secure enclave cloud environment using code that includes proper attestation from an auditor.

17. The cloud environment of claim 16, wherein the code management module notifies all stakeholders when a request to update the list of allowed queries is received.

18. A non-transitory computer readable medium storing instructions operable to cause one or more processors to perform operations comprising:
receiving, by a query module operating within a secure enclave cloud environment, a query from a message processing computing platform external to the secure enclave cloud environment;
determining, by the query module, that the query has a valid query signature;
determining, by the query module, that the query matches a list of allowed queries maintained by the query module;
providing, by the query module, the query to a privacy attested AI module within the secure enclave cloud environment;
generating a query result for the query using a trained model on the privacy attested AI module;
providing, by the privacy attested AI module, the query result to the query module; and
sending, by the query module, the query result to the message processing computing platform.

19. The non-transitory computer readable medium of claim 18, wherein the query module is configured such that the list of allowed queries can only be updated by a code management module within the secure enclave cloud environment using code that includes proper attestation from an auditor.

20. The non-transitory computer readable medium of claim 19, wherein the code management module notifies all stakeholders when a request to update the list of allowed queries is received.
